(19) United States
(12) Patent Application Publication
(10) Pub. No.: US 2025/0197976 A1
(43) Pub. Date: Jun. 19, 2025

(54) CEMENTED CARBIDE MATERIAL

(71) Applicant: Element Six GmbH, Burghaun (DE)

(72) Inventors: Igor Yurievich KONYASHIN, Burghaun (DE); Bernd Heinrich RIES, Burghaun (DE)

(21) Appl. No.: 18/847,808

(22) PCT Filed: Mar. 14, 2023
(86) PCT No.: PCT/EP2023/056449

§ 371 Date: Sep. 17, 2024

(30) Foreign Application Priority Data
Mar. 30, 2022 (GB) 2204522.3

(51) Int. Cl. C22C 29/08; B22F 3/16; B22F 3/24; B22F 9/04; C22C 1/051; C22C 29/06; C22C 38/18

(52) U.S. Cl. CPC C22C 29/08; B22F 3/16; B22F 3/24; B22F 9/04; C22C 1/051; C22C 29/067; C22C 38/18; B22F 2003/248; B22F 2009/043; B22F 2201/20; B22F 2301/35; B22F 2302/10; B22F 2304/10; B22F 2998/10; B22F 2999/00

(57) ABSTRACT

A cemented carbide body for neutron shielding and a method of making the same, said cemented carbide body containing WC, Fe and Cr, wherein the Cr is present in an amount from approximately 1 wt. % to approximately 150 wt. % with respect to the Fe content, the cemented carbide body comprising WC grains, cementite grains and dissolved Cr, W and C in an Fe-based binder matrix material.

### FIELD OF THE INVENTION

This disclosure relates generally to cemented carbide material and blocks comprising the same.

### BACKGROUND

Fusion nuclear reactors for fusion power plants, which are presently under intensive development, need materials for protection against intensive neutron irradiation caused by the nuclear fusion processes in an extremely high-temperature plasma. The resulting high-energy neutrons emitted from the plasma must be slowed (moderated) and captured (absorbed) in the walls of the containment vessel surrounding the plasma. The most suitable material for this is known to be tungsten carbide (WC).

Nevertheless, it is impossible to produce 100% dense blocks for the reactor walls from pure tungsten carbide not containing any metallic binder. Furthermore, any porosity in the wall material must avoided.

Conventionally, cobalt (Co) based binders are employed for the fabrication of cemented carbides, however, the employment of conventional WC—Co cemented carbides needed for neutron shielding is problematic as cobalt remains radioactive for a long time according to M. R. Gilbert, T. Eade et al (Waste implications from minor impurities in European DEMO materials. Nuclear Fusion, April 2019, DOI: 10.1088/1741-4326/ab154e). According to the same reference, iron is a significantly better binder material with respect to life of its radioactive isotopes, so that WC—Fe cemented carbides are preferred for the fabrication of the blocks forming the reactor walls needed for neutron shielding. However, it is well-known (for example, see B. Uhrenius, H. Pastor, E. Pauty, On the composition of Fe—Ni—Co—WC-based cemented carbides, Int. J Refractory Met Hard Mater. 15(1997)139-149) that, the two-phase region, i.e. the region in which only the carbide phases and binder phase coexist in the equilibrium, for cemented carbides with iron-based binders at 1000° C. is very narrow (of the order of 0.01 wt. % or less), which is more than 10 times lower in comparison with that of conventional WC—Co cemented carbides. This causes significant difficulties in the production of cemented carbide with iron binders, since very insignificant deviations in the carbon content in the initial WC—Fe graded powder and in the atmosphere of sintering furnaces lead to the formation of either η-phase or free carbon, which are very brittle. On that ground, WC—Fe cemented carbides are not fabricated in the cemented carbide industry, as it is hardly possible to produce them without inclusions of η-phase or free carbon, which make them very brittle and unacceptable for fabricating and brazing the abovementioned blocks for the fusion nuclear reactor walls.

It is a major objective of the invention to overcome the difficulty mentioned above.

### SUMMARY

The objective of the present invention is achieved by alloying the binder phase with chemical elements that remain radioactive for a relatively short time. It has been surprisingly found out that additions of powders of different chemical elements, in particular chromium, to WC—Fe graded powders in particular amounts as described herein allows broadening of the region of W—C—Fe phase diagram in which only carbide phases, i.e. WC and cementite, and a metallic binder, i.e. Fe-based binder, are present in the equilibrium thus ensuring the possibility of fabricating such cemented carbides on a production scale without significant technological difficulties.

Accordingly, in a first aspect of the invention, there is provided a cemented carbide body for neutron shielding, said cemented carbide body containing, e.g. comprising, consisting of or consisting essentially of, WC, Fe and Cr, wherein the Cr is present in an amount equal to or less than 6 wt. % with respect to the Fe content, a microstructure of the cemented carbide body comprising, consisting of or consisting essentially of WC grains, cementite grains and dissolved Cr, W and C in an Fe-based binder matrix material.

As an option, the cemented carbide body comprises up to 5 wt. % Si, Ti, V, Ge, Ta, Pb and/or Y and a combination of them with respect to the iron content.

As an option, the cemented carbide body comprises up to 50 wt. % Mn with respect to the Fe content.

According to a second aspect of the invention, there is provided a cemented carbide body for neutron shielding, said cemented carbide body containing, e.g. comprising, consisting of, or consisting essentially of, WC, Fe and Cr, wherein the Cr is present in an amount from approximately 1 wt. % to approximately 150 wt. % with respect to the Fe content, the cemented carbide body comprising, consisting of or consisting essentially of WC grains, cementite grains and dissolved Cr, W and C in an Fe-based binder matrix material.

As an option, the Cr is present in an amount from approximately 1 wt. % to approximately 90 wt. % with respect to the Fe content.

As an option, the Cr is present in an amount from approximately 1 wt. % to approximately 10 wt. % with respect to the Fe content.

As an option, the Cr is present in an amount from approximately 1 wt. % to approximately 6 wt. % with respect to the Fe content.

As an option, the Cr is present in an amount from approximately 5 wt. % to approximately 90 wt. % with respect to the Fe content.

As an option, the Cr is present in an amount from approximately 5 wt. % to approximately 10 wt. % with respect to the Fe content.

As an option, the cemented carbide body has a Vickers Hardness of at least 15 GPa. Vickers Hardness is measured according to ISO 6507-1:2018 (Metallic materials—Vickers hardness test—Part 1: Test method).

As an option, the cemented carbide body has a Palmquist fracture toughness of at least 7 MPa m^{1/2}. Palmquist fracture toughness is measured according to ISO 28079:2009 (Hardmetals—Palmqvist toughness test).

As an option, the cemented carbide body comprises less than 0.01 wt. % free carbon.

By free carbon herein it is meant carbon in the cemented carbide body that is present in elemental form, for example in the form of graphite.

As an option, the cemented carbide body is substantially free of free carbon.

As an option, the cemented carbide body comprises less than 0.01 wt. % η-phase.

As an option, the cemented carbide body is substantially free of η-phase.

As an option, the porosity of the cemented carbide body is less than 1%.

As an option, the porosity of the cemented carbide body is less than 0.1%.

As an option, the cemented carbide body is fully dense.

As an option, the cemented carbide body is free of porosity.

Characterization of porosity, carbon defects and η-phase content is performed according to ISO 4499-4:2016 (Hardmetals—Metallographic determination of microstructure—Part 4: Characterisation of porosity, carbon defects and eta-phase content).

As an option, the cemented carbide body further comprises up to 5 wt. % Si, Ti, V, Ge, Ta, Pb and/or Y and a combination of them with respect to the iron content.

As an option, the cemented carbide body further comprises up to 50 wt. % Mn with respect to the Fe content.

According to a third aspect of the invention, there is provided a method of making the cemented carbide body as described herein, the method comprising: milling together powders of tungsten carbide, iron and a chromium containing material; pressing the milled powder to form a green body; sintering the green body in a vacuum at a temperature of no more than 1300° C. and for a time of at least 15 minutes; and cooling the sintered body.

As an option, the method further comprises adding Si, Ti, V, Ge, Ta, Pb, Y and/or Mn in the form of carbides, nitrides, carbonitrides or intermetallic compounds, for example, in the milling step to provide a milled powder comprising Si, Ti, V, Ge, Ta, Pb, Y and/or Mn in the form of carbides, nitrides, carbonitrides or intermetallic compounds.

According to a fourth aspect of the invention, there is provided a method of making the cemented carbide body as described herein, the method comprising: milling together powders of tungsten carbide, iron and a chromium containing material; pressing the milled powder to form a green body; sintering the green body in a vacuum; and cooling the sintered body.

As an option, the sintering is at a temperature of at least 1200° C.

As an option, the sintering is at a temperature of no more than 1300° C. and/or for a time of at least 15 minutes.

As an option, the sintering is at a temperature of at most 1500° C.

As an option, the sintering is at a temperature of from approximately 1250° C. to approximately 1480° C.

As an option, the sintering is for a time of at least 15 minutes.

As an option, the chromium containing material is or comprises a chromium carbide or chromium nitride.

As an option, the chromium carbide is Cr₃C₂.

As an option, the method further comprises adding Si, Ti, V, Ge, Ta, Pb, Y and/or Mn in the form of carbides, nitrides, carbonitrides or intermetallic compounds, for example, in the milling step to provide a milled powder comprising Si, Ti, V, Ge, Ta, Pb, Y and/or Mn in the form of carbides, nitrides, carbonitrides or intermetallic compounds.

According to a fifth aspect of the invention, there is provided a block for forming a wall of a fusion nuclear reactor, said block comprising the cemented carbide body as described herein.

According to a sixth aspect of the invention, there is provided use of a cemented carbide body as described herein in fusion nuclear reactors.

### BRIEF DESCRIPTION OF THE DRAWINGS

A non-limiting example to illustrate the present disclosure is described with reference to the accompanying drawings, in which:

FIG. 1 is a light microscopy image of the cemented carbide body made in accordance with Example 1 after etching in the Murakami reagent;

FIG. 2 is a light microscopy image of the cemented carbide body made in accordance with Example 1 after etching in the Nital reagent;

FIG. 3 is a light microscopy image of the cemented carbide body made in accordance with Example 2 after etching in the Murakami reagent;

FIG. 4 is a light microscopy image of the cemented carbide body made in accordance with Example 2 after etching in the Nital reagent;

FIG. 5 is a light microscopy image of the cemented carbide body made in accordance with Example 3 after etching in the Murakami reagent;

FIG. 6 is a light microscopy image of the cemented carbide body made in accordance with Example 3 after etching in the Nital reagent;

FIG. 7 is a light microscopy image of the cemented carbide body made in accordance with Example 4 after etching in the Murakami reagent;

FIG. 8 is a light microscopy image of the cemented carbide body made in accordance with Example 4 after etching in the Nital reagent;

FIG. 9 is a light microscopy image of the cemented carbide body made in accordance with Example 5 after etching in the Murakami reagent;

FIG. 10 is a light microscopy image of the cemented carbide body made in accordance with Example 5 after etching in the Nital reagent;

FIG. 11 is a high-resolution scanning electron microscope image of the cemented carbide body made in accordance with Example 5 without etching; and

FIG. 12 is a high-resolution scanning electron microscope image of the cemented carbide body made in accordance with Comparative Example 1 without etching.

### DETAILED DESCRIPTION

A series of experiments were performed to identify the optimum range of chromium content. The composition of the lab batches of starting material is shown in Table 1.

| | | | | Cr₃C₂ content | Cr content |
|---|---|---|---|---|---|
| | | | | with respect | with respect |
| | Amount | Amount | Amount | to Fe content/ | to Fe content/ |
| | Fe/g | Cr₃C₂/g | WC/g | wt. % | wt. % |
| Example 1 | 500 | 30 | 9470 | 6 | 5.2 |
| Example 2 | 500 | 50 | 9450 | 10 | 8.7 |
| Example 3 | 500 | 80 | 9420 | 16 | 13.9 |
| Example 4 | 500 | 150 | 9350 | 30 | 26.1 |
| Example 5 | 500 | 500 | 9000 | 100 | 87 |
| Comparative | 500 | 1000 | 8500 | 200 | 174 |
| Example 1 | | | | | |
| Comparative | 500 | 5 | 9495 | 1 | 0.87 |
| Example 2 | | | | | |

### Example 1

A lab batch of a WC—Fe powder (10 kg) was made by milling together 500 g Fe, 30 g Cr₃C₂ powder and 9470 WC powder as well as 180 g paraffin wax with 30 kg WC—Co balls in hexane. The WC powder had a mean grain size of about 6 μm. The Fe powder had a mean grain size of around 3 μm and the Cr₃C₂ powder had a mean grain size of about 2 μm. These components were milled together in a ball-mill for 30 hrs. The ETC (Equivalent Total Carbon) value of this mixture was equal to nearly 5.93 wt. %.

After milling, the resultant slurry was dried at a temperature of around 90° C. followed by sieving, which leads to a graded powder suitable for pressing in dies. Cylindrical samples of 20 mm in diameter and 10 mm in height were pressed from this graded powder and sintered in a Sinter-HIP furnace at a temperature of 1280° C. for 75 min (45 min vacuum+30 min sintering under Ar pressure of 40 Bar).

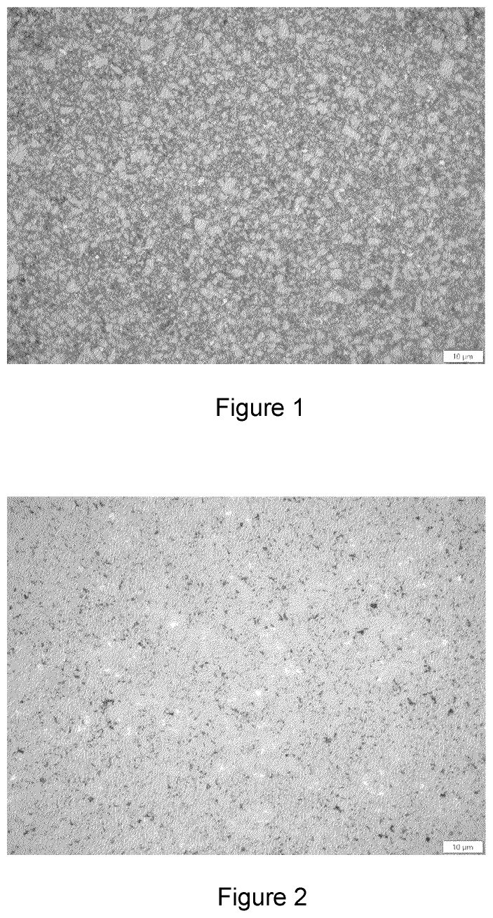

As a result of the sintering process, fully dense samples not containing any inclusion of η-phase or free carbon were obtained. The microstructure of one of such samples after etching in different reagents is shown in FIGS. 1 and 2. As one can see in FIG. 1, the sample subjected to etching in the Murakami reagent does not contain η-phase, and as can be seen in FIG. 2, the microstructure comprises some cementite, which is visible as white or bright-grey inclusions after etching in the Nital reagent. No other carbide phases except for WC and cementite were found to be present in the microstructure, indicating that the added amount of chromium carbide is completely dissolved in the binder phase during liquid-phase sintering. The samples were found to have a value of Vickers hardness of nearly 15.5 GPa and a value of Palmquist fracture toughness of about 9 MPa m^{1/2}. The combination of hardness and fracture toughness is close to that for conventional WC—Co cemented carbides, e.g. see Roebuck B, Gee M G, Morrell R. Hardmetals—microstructural design, testing and property maps. In: Kneringer G, Rödhammer P, Wildner H, editors. Proceedings of the 15th International Plansee Seminar, Vol. 4. Reutte; 2001. p. 245-66.

Afterwards, insignificant (i.e. small) amounts of the graded powder were mixed with different amounts of tungsten metal powder with a mean grain size of about 0.5 μm and carbon black in such a way that the ETC value steadily decreased down to 5.8 wt. % on the one hand and increased up to 6.1 wt. % on the other hand step by step with intervals equal to 0.02 wt. % C. Samples from the mixtures of the graded powders obtained in such a way were pressed and sintered at conditions mentioned above. Afterwards, cross-sections were prepared and examined with respect to the presence of η-phase and free carbon. It was established that the range of carbon contents, at which no η-phase and free carbon are present in the microstructure, was equal to about 0.14 wt. %, which is comparable with that of conventional WC—Co cemented carbides.

### Example 2

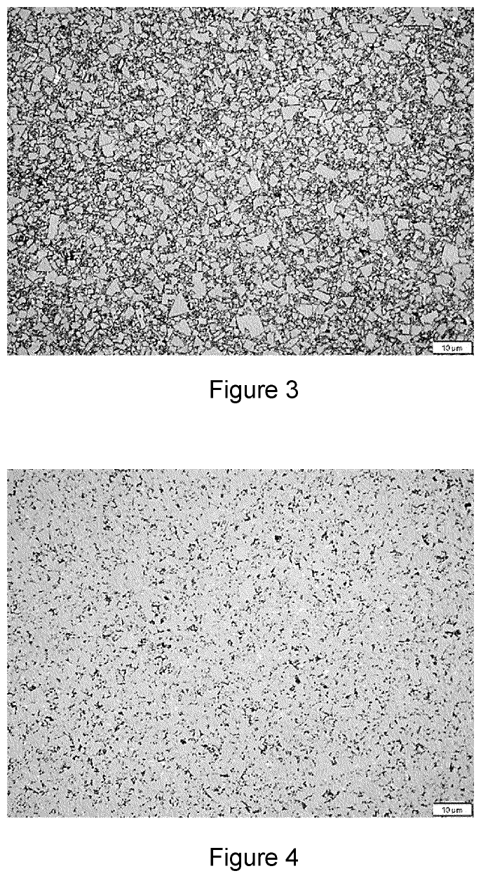

The samples were produced as in Example 1, except that 50 g of chromium carbide powder was added and the amount of WC reduced accordingly to provide a 10 kg batch. As a result of the sintering process, fully dense samples not containing any inclusion of η-phase or free carbon were obtained. As can be seen in FIG. 3, the sample subjected to etching in the Murakami reagent does not contain η-phase, and as can be seen in FIG. 4, the microstructure comprises some cementite, which is visible as white or bright-grey inclusions after etching in the Nital reagent. No other carbide phases except for WC and cementite were found to be present in the microstructure, which was confirmed by XRD studies. The samples were found to have a value of Vickers hardness of nearly 15.7 GPa and a value of Palmquist fracture toughness of about 8.4 MPa m^{1/2}, which is lower than that of Example 1.

### Example 3

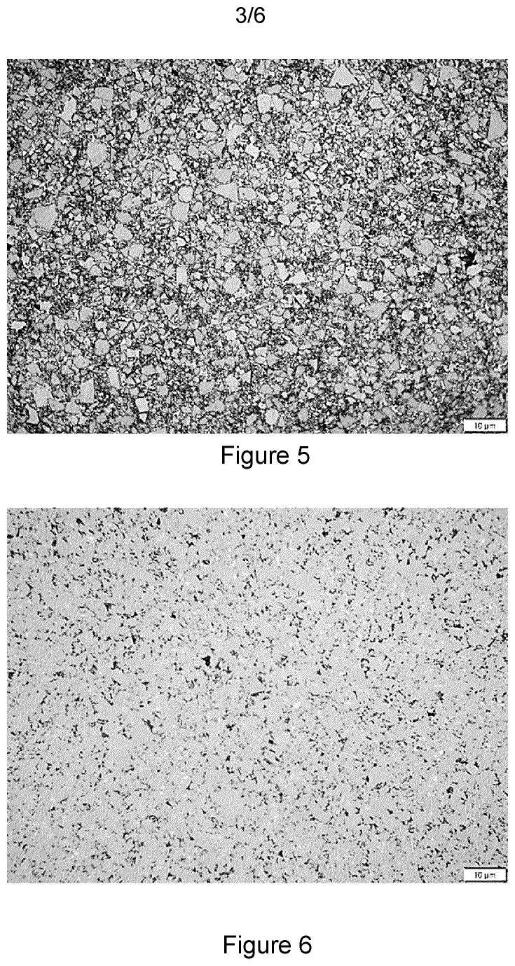

The samples were produced as in Example 1, except that 80 g of chromium carbide powder was added and the amount of WC reduced accordingly to provide a 10 kg batch. As a result of the sintering process, fully dense samples not containing any inclusion of η-phase or free carbon were obtained. As can be seen in FIG. 5, the sample subjected to etching in the Murakami reagent does not contain η-phase, and as can be seen in FIG. 6, the microstructure comprises some cementite, which is visible as white or bright-grey inclusions after etching in the Nital reagent. The sample comprises also inclusions of mixed carbide (Cr,Fe)ₓC_{y}, which are visible in FIG. 6 as dark inclusions and was confirmed by XRD studies. These mixed carbide inclusions have a dark-brown colour, which is typical for mixed Cr—Fe carbides. The samples were found to have a value of Vickers hardness of nearly 15.9 GPa and a value of Palmquist fracture toughness of about 7.6 MPa m^{1/2}, which is lower than in Examples 1 and 2. This comparatively lower value of fracture toughness is likely related to the presence of inclusions of mixed Cr—Fe carbide in the microstructure.

### Example 4

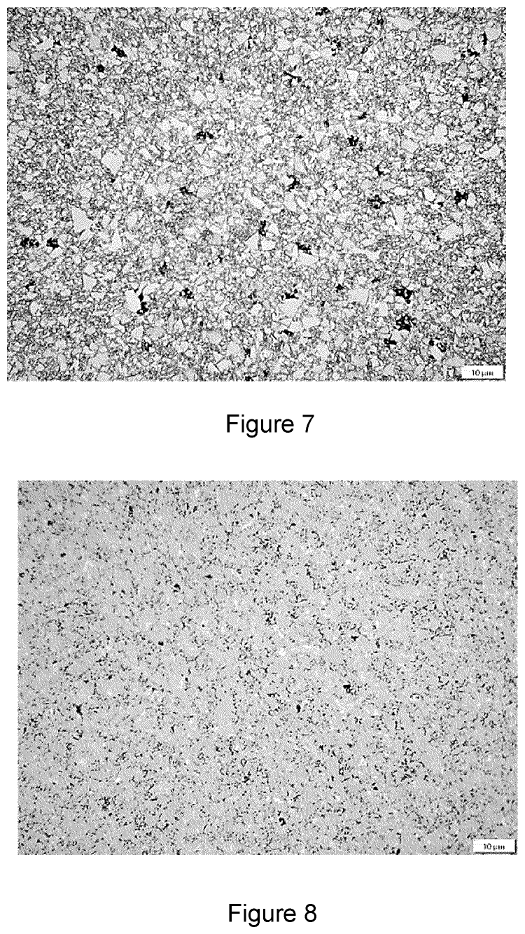

The samples were produced as in Example 1, except that 150 g of chromium carbide powder was added and the amount of WC reduced accordingly to provide a 10 kg batch. As a result of the sintering process, fully dense samples not containing any inclusion of η-phase or free carbon were obtained. As can be seen in FIG. 7, the sample subjected to etching in the Murakami reagent does not contain n-phase, and as can be seen in FIG. 8, the microstructure comprises much cementite, which is visible as white or bright-grey inclusions after etching in the Nital reagent. The samples were found to have a value of Vickers hardness of nearly 16.5 GPa and a value of Palmquist fracture toughness of about 7.4 MPa m^{1/2}, which is lower than in Examples 1 and 2. This comparatively lower value of fracture toughness is likely related to the fact that almost all the Fe-binder is transformed into cementite.

### Example 5

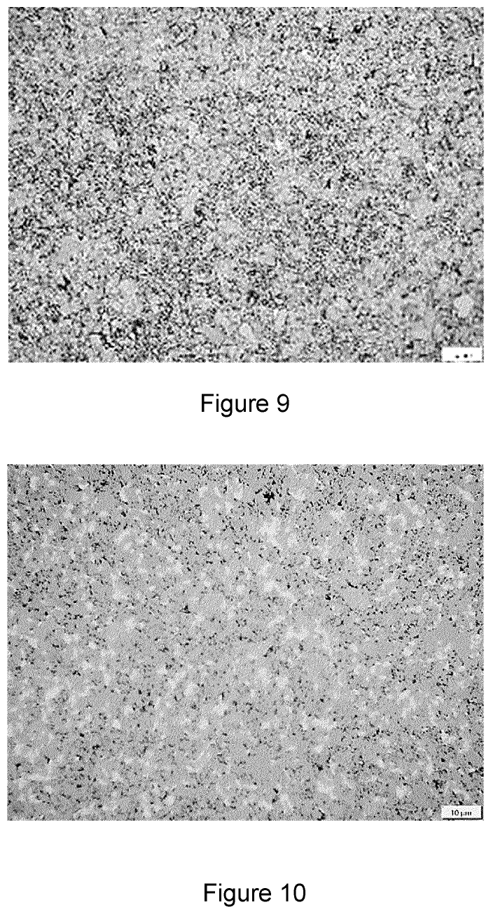

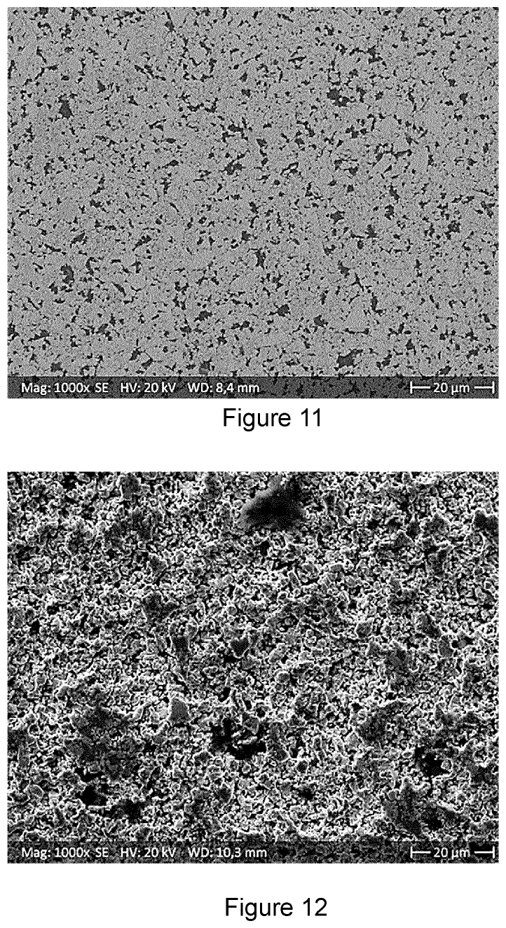

The samples were produced as in Example 1, except that 500 g of chromium carbide powder was added and the amount of WC reduced accordingly to provide a 10 kg batch. As a result of the sintering process, fully dense samples not containing any inclusion of η-phase or free carbon were obtained. As can be seen in FIG. 9, the sample subjected to etching in the Murakami reagent does not contain η-phase, and as can be seen in FIG. 10, the microstructure comprises much cementite, which is visible as white or bright-grey inclusions after etching in the Nital reagent. FIG. 11 shows a HRSEM image of the microstructure indicating that it does not comprise any porosity. The samples were found to have a value of Vickers hardness of nearly 16.5 GPa and a value of Palmquist fracture toughness of about 7.0 MPa m, which is lower than in Examples 1 and 2. Such a low value of fracture toughness is likely related to the presence of inclusions of mixed Cr—Fe carbide in the microstructure. Although the fracture toughness is lower than for Examples 1 and 2, it is high enough that the composition of Example 5 can be used to produce articles for neutron shielding.

### Comparative Example 1

The samples were produced as in Example 1, except that 1000 g of chromium carbide powder was added and the amount of WC reduced accordingly to provide a 10 kg batch. As a result of the sintering process, very porous samples were produced. The porosity was so high that the density cannot be measured by the hydrostatic method. A broken surface of one sample is shown in FIG. 12. Such porous samples are not suitable for use in the production of an article for neutron shielding.

### Comparative Example 2

The samples were produced as in Example 1, except that 5 g of chromium carbide powder was added and the amount of WC reduced accordingly to provide a 10 kg batch. As a result of the sintering process, fully dense samples containing inclusions of ql-phase were obtained. 0.01 wt. % carbon black was added to the mixture and the samples were sintered in the same way as in Example 1. As a result, inclusions of free carbon were present in the microstructure indicating that the width of the two-phase region in this alloy is equal to or close to 0; in other words, it is impossible to produce samples free of η-phase and free carbon when using this amount of chromium. Such materials are not suitable for use in the production of an article for neutron shielding.

While this invention has been particularly shown and described with reference to various embodiments, it will be understood by those skilled in the art that various changes in form and detail may be made without departing from the scope of the invention as defined by the appended claims.

1. A cemented carbide body for neutron shielding, said cemented carbide body containing WC, Fe and Cr, wherein the Cr is present in an amount from approximately 1 wt. % to approximately 150 wt. % with respect to the Fe content, the cemented carbide body comprising WC grains, cementite grains and dissolved Cr, W and C in an Fe-based binder matrix material.

2. The cemented carbide body according to claim 1, wherein the Cr is present in an amount from approximately 1 wt. % to approximately 90 wt. % with respect to the Fe content.

3. The cemented carbide body according to claim 1, wherein the Cr is present in an amount from approximately 1 wt. % to approximately 10 wt. % with respect to the Fe content.

4. The cemented carbide body according to claim 1, wherein the Cr is present in an amount from approximately 1 wt. % to approximately 6 wt. % with respect to the Fe content.

5. The cemented carbide body according to claim 1, which has a Vickers Hardness of at least 15 GPa.

6. The cemented carbide body according to claim 1, which has a Palmquist fracture toughness of at least 7 MPa m^{1/2}.

7. The cemented carbide body according to claim 1, which is substantially free of free carbon.

8. The cemented carbide body according to claim 1, which is substantially free of η-phase.

9. The cemented carbide body according to claim 1, wherein the porosity of the cemented carbide body is less than 0.10%.

10. The cemented carbide body according to claim 1, further comprising up to 5 wt. % Si, Ti, V, Ge, Ta, Pb and/or Y and a combination of them with respect to the iron content.

11. The cemented carbide body according to claim 1, further comprising up to 50 wt. % Mn with respect to the Fe content.

12. A method of making the cemented carbide body according to claim 1, the method comprising:
milling together powders of tungsten carbide, iron and a chromium containing material;
pressing the milled powder to form a green body;
sintering the green body in a vacuum; and
cooling the sintered body.

13. The method according to claim 12, wherein the sintering is at a temperature of at least 1200° C.

14. The method according to claim 12, wherein the sintering is at a temperature of at most 1500° C.

15. The method according to claim 12, wherein the sintering is at a temperature of from approximately 1250° C. to approximately 1480° C.

16. The method according to claim 12, wherein the sintering is for a time of at least 15 minutes.

17. The method according to claim 12, wherein the chromium containing material is a chromium carbide or chromium nitride.

18. The method according to claim 17, where the chromium carbide is Cr₃C₂.

19. The method according to claim 18, wherein the cemented carbide body comprises up to 5 wt. % Si, Ti, V, Ge, Ta, Pb and/or Y and a combination of them with respect to the iron content, the method further comprising adding Si, Ti, V, Ge, Ta, Pb, Y and/or Mn in the form of carbides, nitrides, carbonitrides or intermetallic compounds.

20. A block for forming a wall of a fusion nuclear reactor, said block comprising the cemented carbide body according to claim 1.

21. (canceled)
